(19) United States
(12) Patent Application Publication
(10) Pub. No.: US 2008/0127162 A1
(43) Pub. Date: May 29, 2008

(54) Method and apparatus for configuring application software

(75) Inventors: Kui Xu, Shanghai (CN); Yujie Hu, Shanghai (CN); Ting Wang, Shanghai (CN)

Correspondence Address: SAP/BLAKELY, 1279 OAKMEAD PARKWAY, SUNNYVALE, CA, 94085-4040, US

(73) Assignee: SAP AG

(21) Appl. No.: 11/606,840

(22) Filed: Nov. 29, 2006

(51) Int. Cl. G06F 9/44; G06F 7/00

(52) U.S. Cl. 717/168; 707/101; 719/319; 707/E17.032

(57) ABSTRACT

A cross-platform configuration system manages configuration information for application software. In one embodiment, a process includes, but is not limited to, storing configuration information in a configuration file using a cross-platform markup language, the configuration information including configuration data associated with the operating environment and user data associated with the application, and configuring the application by accessing the configuration file without using a registry of an operating environment in which the application is running.

### COPYRIGHT NOTICES

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to application software. More particularly, this invention relates to a cross-platform configuration system for configuring application software.

### BACKGROUND

Computer registry files generally include one or more machine configuration files and user profiles, which store information necessary to configure the computer for one or more users, applications, and hardware devices. The information is continually or periodically referenced by an operating system and application software during operation. The information includes, but is not limited to, profiles of each user, applications installed on the computer, types of documents that each user can create, property settings for folders and icons, installed hardware, and ports that are being used. Whenever there is a change to the settings for hardware, software, or users, the changes are reflected and stored in registry files.

Registry files are generally platform-dependent. For example, many existing computing systems use Windows Registry for managing registry files. Windows Registry is used exclusively on Windows® platforms and cannot be used for a system running a different operating system, e.g., a Unix or a Linux operating system. Thus, conventional registry files are generally managed on a machine-by-machine basis and are difficult to transfer across different platforms.

Further, registry files often contain sensitive information, e.g. user login information or personal data, which needs to be protected from unauthorized access.

### SUMMARY OF THE DESCRIPTION

A cross-platform registry system manages configuration information for application software. In one embodiment, a process includes, but is not limited to, storing configuration information in a configuration file using a cross-platform markup language, the configuration information including configuration data associated with the operating environment and user data associated with the application, and configuring the application by accessing the configuration file without using a registry of an operating environment in which the application is running.

Other features of the present invention will be apparent from the accompanying drawings and from the detailed description which follows.

### BRIEF DESCRIPTION OF THE DRAWINGS

The present invention is illustrated by way of example and not limitation in the figures of the accompanying drawings in which like references indicate similar elements.

FIG. 1 is a block diagram showing an embodiment of Easy Registry, which is in communication with application software.

FIG. 2 is a diagram showing an embodiment of a data structure of a registry file.

FIG. 3 shows an example of a registry file.

FIG. 4 is a flowchart showing an embodiment of a read process and a write process performed by Easy Registry.

FIG. 5 is a block diagram of a data processing system, which may be used with one embodiment of the invention.

### DETAILED DESCRIPTION

A cross-platform registry system for managing registry information is described herein. In the following description, numerous details are set forth to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment.

Accordingly, a configuration file that is cross-platform is designed to configure an application without having to rely on a platform dependent configuration mechanism, such as, for example, a registry of an operating system (OS) (e.g., Windows Registry of Windows operating system available from Microsoft). In one embodiment, a configuration file includes information similar to those stored in a registry of an OS, but is specifically associated with a particular application. This configuration file is cross-platform and portable across a variety of different platforms. In other words, this configuration file is used to simulate a registry associated with an application, herein also referred to as an Easy Registry because it is “easy” to use across multiple platforms. Similarly, a configuration file sometimes is referred to a registry file for the Easy Registry purposes, but it is not the same as a register file of a registry of an OS.

Easy Registry is a cross-platform register system that can be easily deployed on different platforms that execute different operating systems. Easy Registry provides machine-specific configuration data and user-specific data to application software that may be ported to different platforms. An example of such application software is the SAP Business One, which is a product of SAP AG located in Germany. The machine-specific data and user-specific data are stored in certain cross-platform markup languages such as an extensible markup language (XML) format. As a result, Easy Registry reduces the overhead in porting registry information to different platforms.

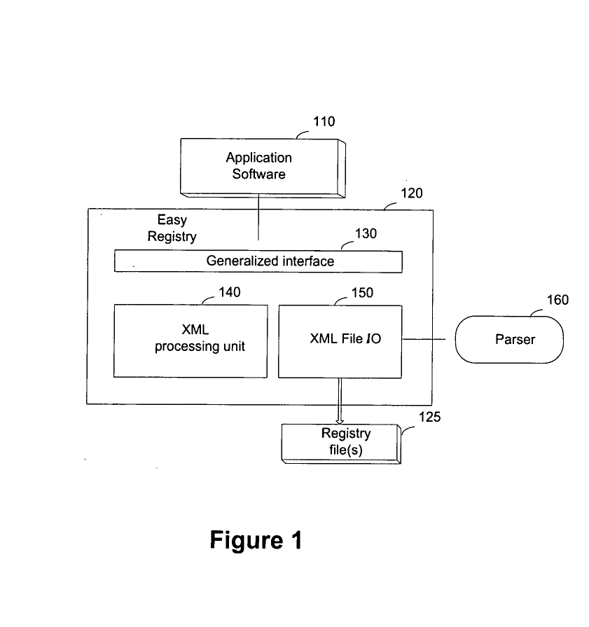

FIG. 1 is a block diagram illustrating an embodiment of Easy Registry 120, which is in communication with application software 110. Application software 110 may be a computer program for any purpose and programmed in a programming language such as C++. During an operation, application software 110 may need information regarding a configuration of the platform or a profile of the user as well as other configuration information associated with the application software 110, and may update the information to reflect changes. The information includes, but is not limited to, a software version, a user preference, an access restriction, a hardware setting, and available hardware/software. The information is stored in one or more configuration or registry files 125, which are coded in, for example, XML and each organized as a separate data tree. Registry files 125 include configurations files which contain data specific to the machine on which application software 110 runs. Registry files 125 also include user profiles which contain data specific to each user of application software 110. Easy Registry 120 retrieves and updates the information in registry files 125 for application software 110. As registry files 125 adopt the XML format, they are not platform-dependent. Thus, registry files 125 can be ported with application software 110 to whichever platforms and operating environments. Note that throughout this application, XML is utilized to implement a configuration or register file for the purposes of illustration only.

Easy Registry 120 includes a generalized (e.g., cross-platform) interface 130, an XML processing unit 140, and an XML file I/O 150. XML file I/O 150 accesses registry files 125 and reads an XML parser 160, e.g., Xerces, which is an open-source XML parser. XML file I/O 150 reads registry files 125 and forwards the files to XML processing unit 140. XML processing unit 140 maps data items in registry files 125 onto an internal memory structure that has the same structure of the data trees of registry files 125. The internal memory structure may be implemented in a random access memory (RAM) that is static, dynamic, or any suitable type, a flash memory, a disk, or other types of machine-readable storage media. The mapping allocates memory space to the data items in the data trees and thus avoids having to access registry files 125 each time a data item is accessed. The internal memory structure stores data items and their associated attributes. The associated attributes include, but are not limited to, a data format of the data item (e.g., binary, decimal, unsigned long, Boolean, or character string). During the mapping, XML processing unit 140 uses XML parser 160 to parse the data items, e.g., checking syntactic errors in the XML code. If no syntactic error is detected, the entire registry files 125 will be loaded into the memory. At this point, the registry information is ready for access by application software 110. It is understood that the components of Easy Registry 120 are shown for illustration purposes only and other configurations may exist.

If application software 110 is ported to a different platform, e.g., a different machine running a different version of the operating system or a different machine running an entirely different operating system, registry files 125 can also be ported without any change. The components inside Easy Registry 120, as shown in FIG. 1, may need to be recompiled to a different machine code but re-programming of these components is not necessary. Thus, the use of Easy Registry 120 eases the deployment onto different platforms and improves the efficiency of system administration.

Registry files 125 can be directly edited by any XML editor that runs on any platform. Registry files 125 can also be indirectly modified by application software 110. For example, during the operation of application software 110, a user may update his/her preferred background setting in the graphical user interface (GUI). To record the changed setting in registry files 125, application software 110 submits a write request through generalized interface 130 to update the corresponding data item in the internal memory structure. The write request includes a value of the data item, the attributes of the data item, and a path of the data item in the data tree. The change is also saved in registry files 125 to ensure consistency of the data items in the memory and in the registry file. In another example, a new user may be added to the list of authorized users for application software 110. To create the new user's file into registry files 125, application software 110 submits a write request through generalized interface 130 to add a new registry file that contain the user data of the new user. The new registry file is saved in the internal memory structure and in registry files 125. Note that some or all of the components or modules as shown in FIG. 1 may be implemented in software, hardware, or a combination of both.

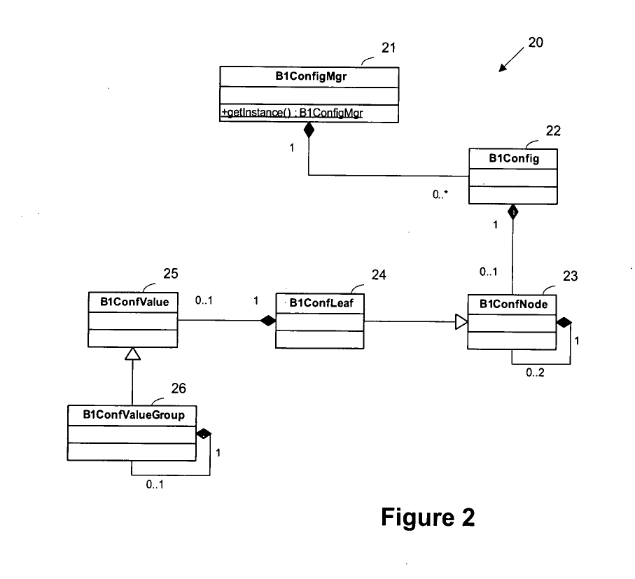

FIG. 2 illustrates an embodiment of a data structure stored in registry file 125 of FIG. 1. The data structure is shown in the form of a Unified Modeling Language (UML) class diagram 20, which is a standardized modeling tool for object-oriented software design. At the top level of class diagram 20 is a class object B1ConfigMgr 21, which is the object interfaced with application software 110. That is, application software 110 requests registry information by passing parameters through B1ConfigMgr 21. Each implementation of Easy Registry 120 only initializes one instance of class B1ConfigMgr 21. Under B1ConfigMgr 21, one or more data trees are maintained by B1Config 22, in terms of B1ConfNode 23, B1ConfLeaf 24, B1ConfValue 25, and B1ConfValueGroup 26. A data tree consists of nodes and a root, which is also a node. Each node is the child node of either another node or the root; only the root has no parent node. A node without a child is called leaf. B1Config 22 contains the root of the data tree. Data items, the names of the data items, and the type (or equivalently, the data format) of the data items are stored, in the forms of B1ConfValue 25, B1ConfValueGroup 26, or B1Confleaf 24. The root and all the data items that stored in B1ConfLeaf 24 are connected via B1ConfNode 23. Application software 110 does not need to know the structure of the data tree. Rather, Easy Registry 120 hides the data tree from application software 110 and provides the application software access to the data tree through class object B1ConfigMgr 21. As a result, efficiency in the reading and updating of registry information is increased.

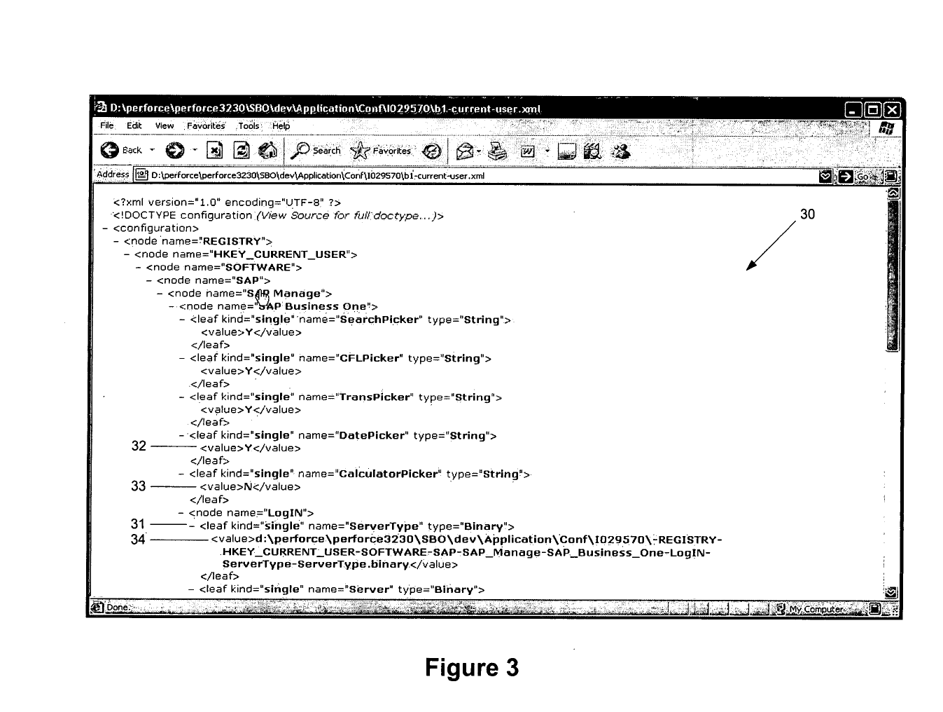

A sample registry file 30 is shown in FIG. 3 according to one embodiment of the invention. Registry file 30 is a user profile that includes user data. The user profile is coded in XML and organized as a data tree. The “leaf kind” in registry file 30, e.g., leaf kind 31, defines the attributes of a data item, which can be single (a single value) or group (a group of values). The name of a specific item to be stored (e.g., ServerType, SearchPicker, CFLpicker, Transpicker, DatePicker, CalculatorPicker, etc.) is specified under “name.” The type of data (e.g., a binary data format) is specified under “type.” The value of a data item can be a Boolean value (e.g., Yes 32 or No 33), a number, or a link to another data file, e.g., link 34. The data file linked to registry file 30 can have any data format, including, but is not limited to, plain text, binary, decimal, and character string. The data file linked to registry file 30 may be encrypted for security reasons.

In the example of FIG. 3, the login information of a user is stored in an encrypted binary file, which can be located by link 34 indicated in the following path: d:\perforce\perforce3230\SBO\dev\Application\Conf\I029570\-REGISTRY-HKEY_CURREN T_User-SOFTWARE-SAP-SAP_Manage-SAP_Business_One-LogIN-ServerType-ServerTyp e.binary. In this embodiment, link 34 is the full path of the user login file. A relative path may also be used. Thus, instead of storing the user login file as part of registry file 30, the user login file is stored in a separate location which is subject to a higher level of protection. Thus, the contents of the user login file cannot be modified by application software 110 of FIG. 1. It is understood that the above discussion is not limited to user login files and is equally applicable to any data files of any data format. The use of the link ensures the integrity of the linked data files, even when registry file 30 is ported to an unsecured environment and attacked by a malicious user.

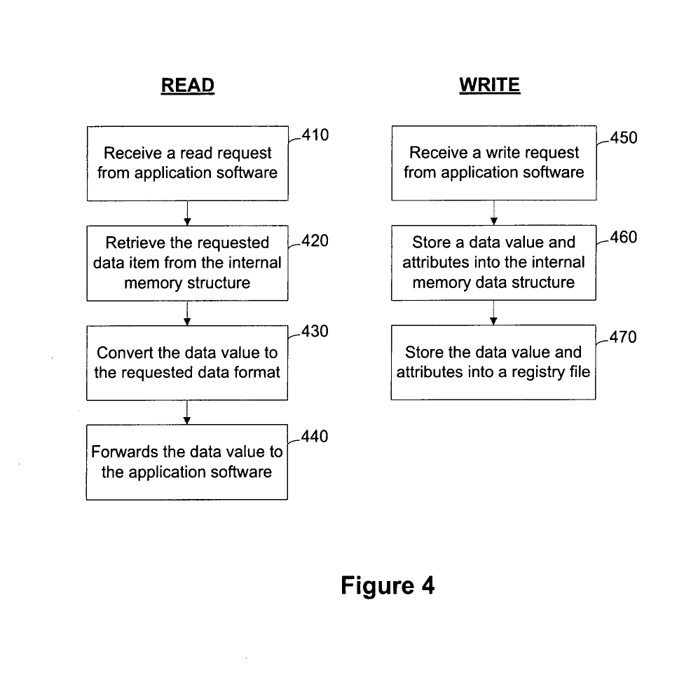

FIG. 4 is a flowchart showing an embodiment of a read process and a write process performed by Easy Registry 120 of FIG. 1. Note that processes as shown in FIG. 4 may be performed by processing logic which may include software, hardware, or a combination of both. For example, these processes may be performed by a system shown in FIG. 1 based on a configuration file having information as shown in FIGS. 2 and 3. At block 410, Easy Registry 120 receives a request through generalized (e.g., cross-platform) interface 130 from application software 110 of FIG. 1 to read a data item. The request includes the full data path of the requested data item and a requested data format. The request is submitted by passing parameters defined in B1ConfigMgr 21 of FIG. 2. At block 420, XML processing unit 140 retrieves the data item from the internal memory structure according to the data path. At block 430, XML processing unit 140 converts the retrieved data value to the requested data format, and at block 440, forwards the result to application software 110 through generalized interface 130.

To write a data item, at block 450, application software 110 submits the full path of the data item and its associated attributes to Easy Registry 120 through generalized interface 130. At block 460, XML processing unit 140 stores the data value and its associated attributes into the specified path in the internal memory structure. To ensure consistency between the memory and registry files 125, at block 470, XML file I/O 140 writes the data item and its associated attributes into registry files 125 through XML file I/O 150. The data item and its associated attributes are written into a location in the corresponding data path of the XML data tree. It is understood that the read and write operations can occur in any order and during any time application software 110 operates. Other operations may also be performed.

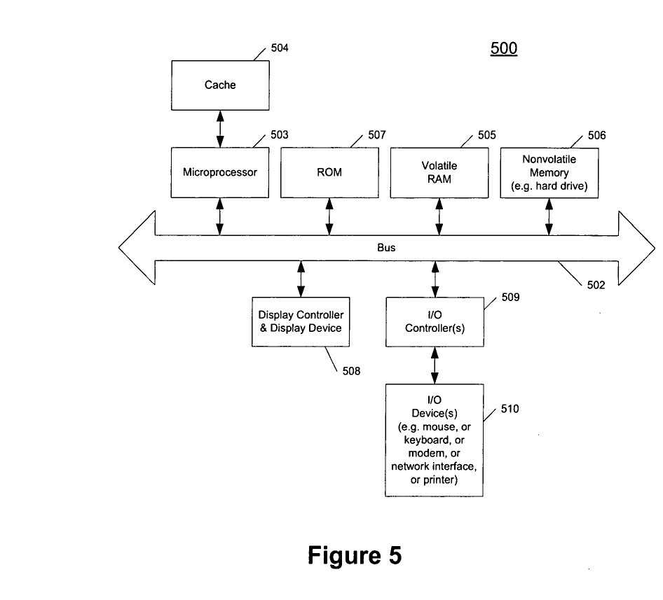

FIG. 5 is a block diagram of a data processing system, which may be used with one embodiment of the invention. System 500 includes sufficient software, hardware, or a combination of both, to implement embodiments of the invention set forth above and/or to perform operations set forth in FIGS. 1-4.

Note that while FIG. 5 illustrates various components of a computer system, it is not intended to represent any particular architecture or manner of interconnecting the components, as such details are not germane to the present invention. It will also be appreciated that network computers, handheld computers, cell phones, servers, personal digital assistants (PDAs), and other data processing systems which have fewer components or perhaps more components may also be used with the present invention. The computer system of FIG. 5 may, for example, be a J2EE compatible system or a .NET framework compatible system.

As shown in FIG. 5, the computer system 500, which is a form of a data processing system, includes an interconnection path (e.g., a bus 502) which is coupled to a microprocessor 503 and a ROM 505, a volatile RAM 505, and a non-volatile memory 506. The microprocessor 503, which may be a PowerPC microprocessor from Motorola, Inc. or IBM, is coupled to cache memory 504 as shown in the example of FIG. 5. Alternatively, processor 503 may be a Pentium Processor from Intel Corporation. Other processors may also be utilized.

The bus 502 interconnects these various components together and also interconnects these components 503, 507, 505, and 506 to a display controller and display device 508, as well as to input/output (I/O) devices 510, which may be mice, keyboards, modems, network interfaces, printers, and other devices which are well-known in the art. Typically, the input/output devices 510 are coupled to the system through input/output controllers 509.

The volatile RAM 505 is typically implemented as dynamic RAM (DRAM) which requires power continuously in order to refresh or maintain the data in the memory. The non-volatile memory 506 is typically a magnetic hard drive, a magnetic optical drive, an optical drive, or a DVD RAM or other type of memory system which maintains data even after power is removed from the system. Typically the non-volatile memory will also be a random access memory, although this is not required.

While FIG. 5 shows that the non-volatile memory is a local device coupled directly to the rest of the components in the data processing system, it will be appreciated that the present invention may utilize a non-volatile memory which is remote from the system, such as a network storage device which is coupled to the data processing system through a wire or wireless network interface such as a modem or Ethernet interface. The bus 502 may include one or more buses connected to each other through various bridges, controllers, and/or adapters, as are well-known in the art. In one embodiment, the I/O controller 509 includes a USB (Universal Serial Bus) adapter for controlling USB peripherals. Alternatively, I/O controller 809 may include an IEEE-1394 adapter, also known as FireWire adapter, for controlling FireWire devices.

Thus, a cross-platform configuration system has been described herein. Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.)), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

It is believed that processes taught by the discussion above may also be described in source level program code in various object-orientated or non-object-orientated computer programming languages (e.g., Java, C#, VB, Python, C, C++, J#, APL, Cobol, ABAP, Fortran, Pascal, Perl, etc.) supported by various software development frameworks (e.g., Microsoft Corporation's .NET, Mono, Java, Oracle Corporation's Fusion, etc.). The source level program code may be converted into an intermediate form of program code (such as Java byte code, Microsoft Intermediate Language, etc.) that is understandable to an abstract execution environment (e.g., a Java Virtual Machine, a Common Language Runtime, a high-level language virtual machine, an interpreter, etc.), or a more specific form of program code that is targeted for a specific processor.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A computer-implemented method for configuring an application, the method comprising:
storing configuration information in a configuration file using a cross-platform markup language, the configuration information including configuration data associated with the operating environment and user data associated with the application; and
configuring the application by accessing the configuration file without using a registry of an operating environment in which the application is running.

2. The method of claim 1 wherein the markup language comprises an extensible markup language (XML).

3. The method of claim 1 further comprising linking the configuration file to a binary data file, wherein the binary data file includes encrypted user data.

4. The method of claim 1 further comprising:
mapping a data tree in the configuration file to an internal memory structure, the internal memory structure organized as the data tree.

5. The method of claim 4 further comprising:
receiving a request from the application for reading the configuration information, the request including a requested data format;
retrieving the configuration information from the internal memory structure in response to the request; and
converting a data format of the configuration information if the data format is different from the requested data format.

6. The method of claim 4 further comprising:
receiving a request from the application for updating the configuration information;
updating the configuration information in the internal memory structure in response to the request; and
updating the configuration information in the configuration file.

7. A cross-platform system for managing configuration information, the system comprising:
a configuration file for configuring an application using a cross-platform markup language, the configuration information including configuration data associated with the operating environment and user data associated with the application; and
a configuration module to configure the application by accessing the configuration file without using a registry of an operating environment in which the application is running.

8. The system of claim 7 wherein the markup language comprises an extensible markup language (XML).

9. The system of claim 7 further comprising an interface to receive and respond to a request from the application for reading and updating the configuration file, wherein the configuration file includes a link referencing with a binary file having encrypted user data.

10. The system of claim 7 further comprising a processing unit to map a data tree in the configuration file to an internal memory structure, the internal memory structure organized as the data tree.

11. The system of claim 7 further comprising a file I/O to access the configuration file and to invoke a parser for parsing the configuration file.

12. The system of claim 11 wherein the parser is an open-source XML Xerces compatible parser.

13. The system of claim 7 wherein the interface, after recompilation, is portable with the configuration file from a first platform to a second platform different than the first platform.

14. A machine-readable medium having instructions, when executed, cause a machine to perform a method for configuring an application, the method comprising:
storing configuration information in a configuration file using a cross-platform markup language, the configuration information including configuration data associated with the operating environment and user data associated with the application; and
configuring the application by accessing the configuration file without using a registry of an operating environment in which the application is running.

15. The machine-readable medium of claim 14 wherein the markup language comprises an extensible markup language (XML).

16. The machine-readable medium of claim 14 wherein the method further comprises linking the configuration file to a binary data file, wherein the binary data file includes encrypted user data.

17. The machine-readable medium of claim 14 wherein the method further comprises:
mapping a data tree in the configuration file to an internal memory structure, the internal memory structure organized as the data tree.

18. The machine-readable medium of claim 17 wherein the method further comprises:
receiving a request from the application for reading the configuration information, the request including a requested data format;
retrieving the configuration information from the internal memory structure in response to the request; and
converting a data format of the configuration information if the data format is different from the requested data format.

19. The machine-readable medium of claim 17 wherein the method further comprises:
receiving a request from the application for updating the configuration information;
updating the configuration information in the internal memory structure in response to the request; and
updating the configuration information in the configuration file.
